(19) United States
(12) Patent Application Publication
(10) Pub. No.: US 2017/0264669 A1
(43) Pub. Date: Sep. 14, 2017

(54) INFORMATION PROCESSING APPARATUS, NON-TRANSITORY COMPUTER READABLE MEDIUM AND INFORMATION PROCESSING METHOD

(71) Applicant: FUJI XEROX CO., LTD., Tokyo (JP)

(72) Inventor: Chie OHARA, Yokohama-shi (JP)

(73) Assignee: FUJI XEROX CO., LTD., Tokyo (JP)

(21) Appl. No.: 15/219,622

(22) Filed: Jul. 26, 2016

(30) Foreign Application Priority Data
Mar. 10, 2016 (JP) 2016-046576

(51) Int. Cl. H04L 29/08; H04N 1/32

(52) U.S. Cl. CPC H04L 67/10; H04L 67/146; H04N 1/32101; H04N 2201/0094

(57) ABSTRACT

An information processing apparatus includes a first communication unit communicating with a first device, a second communication unit communicating with a second device, a first transmission unit adding identification information of a request for processing and transmitting the request to the second device using the second communication unit in a case where the first communication unit receives the request and the request is suitable for a transmission using the second communication unit, a control unit performing control such that the identification information and the first communication unit are correlated with each other and are stored in a storage unit, and a second transmission unit extracting a communication unit correlated with the identification information using the storage unit and transmitting a result of the processing to the first device using the extracted communication unit when the result with the identification information is received from the second device.

### CROSS-REFERENCE TO RELATED APPLICATIONS

This application is based on and claims priority under 35 USC 119 from Japanese Patent Application No. 2016-046576 filed Mar. 10, 2016.

### BACKGROUND

The present invention relates to an information processing apparatus, a non-transitory computer readable medium, and an information processing method.

### SUMMARY

According to an aspect of the invention, there is provided an information processing apparatus comprising:

a first communication unit that communicates with a first device connected to a first communication line;

a second communication unit that communicates with a second device connected to a second communication line different from the first communication line;

a first transmission unit that adds identification information identifying the processing to a request for processing and transmits the request for processing to the second device using the second communication unit in a case where the first communication unit receives the request for processing and the request for processing is suitable for a condition in which transmission is performed using the second communication unit;

a control unit that performs control such that the identification information and the first communication unit are correlated with each other and are stored in a storage unit; and

a second transmission unit that extracts a communication unit correlated with the identification information using the storage unit and transmits a result of the processing to the first device using the extracted communication unit in a case where the result of the processing added with the identification information is received from the second device.

### BRIEF DESCRIPTION OF THE DRAWINGS

Exemplary embodiments of the present invention will be described in detail based on the following figures, wherein:

FIG. 1 is a configuration diagram conceptually illustrating modules in an example of a configuration of an exemplary embodiment;

FIG. 2 is a configuration diagram conceptually illustrating modules in an example of a configuration of the exemplary embodiment;

FIG. 3 is an explanatory diagram illustrating another example of the configuration of a system using the exemplary embodiment;

FIG. 4 is an explanatory diagram illustrating an example of a data structure of a port ID and provided service correspondence table;

FIG. 5 is an explanatory diagram illustrating an example of a data structure of a processing and transmission source correspondence table;

FIG. 6 is an explanatory diagram illustrating an example of a data structure of an address table;

FIG. 7 is a flowchart illustrating an example of a process performed by the exemplary embodiment;

FIG. 8 is an explanatory diagram illustrating an example of a process performed by the exemplary embodiment;

FIG. 9 is an explanatory diagram illustrating an example of a data structure of a PIN code and service correspondence table;

FIG. 10 is an explanatory diagram illustrating an example of a data structure of a processing, transmission source and mail address correspondence table;

FIG. 11 is a flowchart illustrating an example of another process performed by the exemplary embodiment;

FIG. 12 is a flowchart illustrating an example of the process performed by the exemplary embodiment;

FIG. 13A and FIG. 13B are explanatory diagrams illustrating an example of a data structure of a processing, transmission source and transmission destination correspondence table;

FIG. 14 is an explanatory diagram illustrating an example of the processing by the exemplary embodiment;

FIG. 15 is a flowchart illustrating an example of still another process performed by the exemplary embodiment;

FIG. 16 is a flowchart illustrating an example of the process performed by the exemplary embodiment; and

FIG. 17 is a block diagram illustrating an example of a hardware configuration of a computer that implements the exemplary embodiment.

### DETAILED DESCRIPTION

Hereinafter, an example of a preferred exemplary embodiment in implementing the present invention will be described on the basis of the drawings.

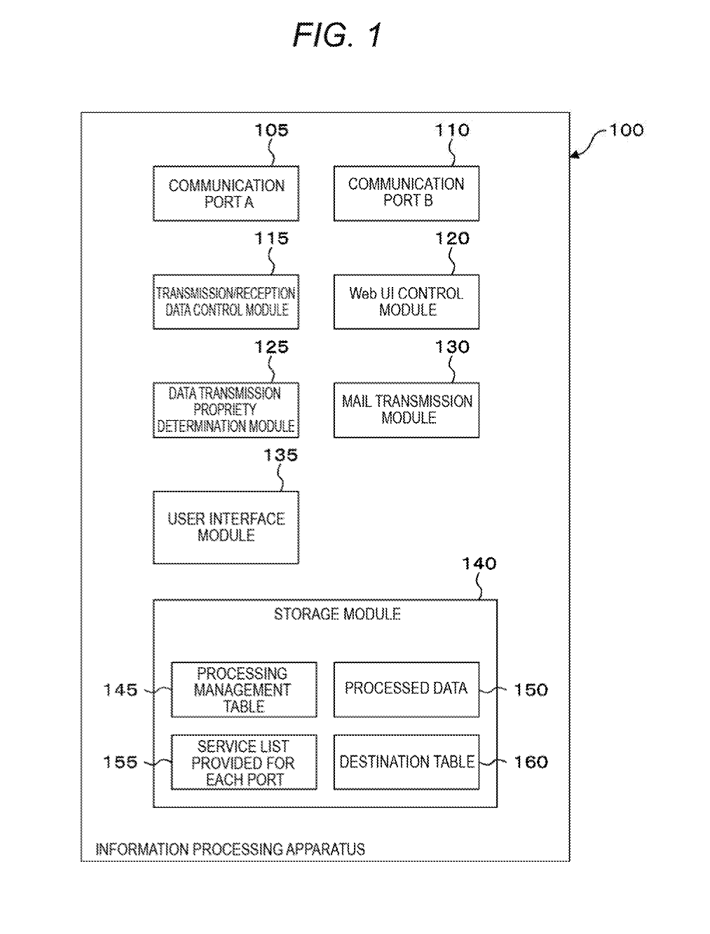

FIG. 1 is a configuration diagram conceptually illustrating modules in an example of a configuration of the exemplary embodiment.

A module generally refers to logically divisible pieces of software (a computer program) or hardware or the like. Accordingly, the module in the exemplary embodiment refers not only to a module in a computer program but also to a module in a hardware configuration. Therefore, in the exemplary embodiment, a computer program that functions as the modules (a program for causing a computer to execute respective procedures, a program for causing a computer to function as respective units, a program for causing a computer to implement respective functions), a system, and a method are also described. For the convenience of explanation, the expressions of “stores”, “is stored”, and other expressions equivalent to the expressions are used. However, in a case where an exemplary embodiment is a computer program, these expressions mean that something is caused to be stored in a storage device or control is performed such that something is stored in the storage device. The module may have a one-to-one correspondence with a function. However, in mounting the modules, a single module may be configured by a single program, plural modules may be configured by a single program, and in an opposite manner, a single module may be configured by plural programs. Furthermore, plural modules may be executed by a single computer or a single module may be executed by plural computers in a distributed or parallel environment. Other modules may be included in a single module. In the following, the expression “connection” is also used in a case of logical connection (sending and receiving of data, issuing of instruction, reference relationship between data, or the like) in addition to physical connection. The expression “predetermined” is used to include the meaning that matters are determined before processing regarded as a target is performed, and matters are determined on the basis of the situation and the state at that time or determined on the basis of the situation and the state until that time before the processing regarded as the target is performed even after the processing in the exemplary embodiment is started as well as before the processing in the exemplary embodiment is started. In a case where there are plural “predetermined values”, the predetermined values may be respectively different values or two or more (also including all the values) of the predetermined values may be the same. The description signifying that “In a case of A, it is regarded as B” is used to signify that “It is determined whether it is A, and when it is determined that it is A, it is regarded as B”. However, a case where the determination as to whether it is A is unnecessary is excluded.

A system or an apparatus is configured in such a way that plural computers, hardware, apparatuses or the like are connected to each other by a communication unit such as a network (including communication connection on one-to-one correspondence), and may be implemented by a single computer, hardware, apparatus or the like. The “apparatus” and the “system” are interchangeably used herein as having the same meaning. The “system” does not include a social “mechanism” (a social system) that is merely an artificial arrangement.

A piece of information regarded as a target is read from the storage device for each processing by each module or for each processing in a case where plural processing is performed in the module and a processing result is written into the storage device after the processing is performed. Accordingly, description of the reading from the storage device before the processing and the writing into the storage device after the processing may be omitted. Here, the storage device may include a hard disk, a RAM, an external storage medium, a storage device through a communication line, a register within a central processing unit (CPU) or the like.

The information processing apparatus 100 which is the exemplary embodiment includes plural communication ports (also referred to as network interfaces) and as illustrated in the example of FIG. 1, includes a communication port A 105, a communication port B 110, a transmission/reception data control module 115, a Web UI control module 120, a data transmission propriety determination module 125, a mail transmission module 130, a user interface module 135, and a storage module 140.

The information processing apparatus 100 is connected to plural communication lines (also referred to as networks). For that reason, the information processing apparatus 100 includes plural communication ports that are communication units. Accordingly, the information processing apparatus 100 is able to communicate with devices placed on the plural communication lines. Hereinafter, although a case of being connected with two communication lines is described, the information processing apparatus 100 may be connected with three or more communication lines.

The communication port A 105 performs communication with a first device connected to a first communication line.

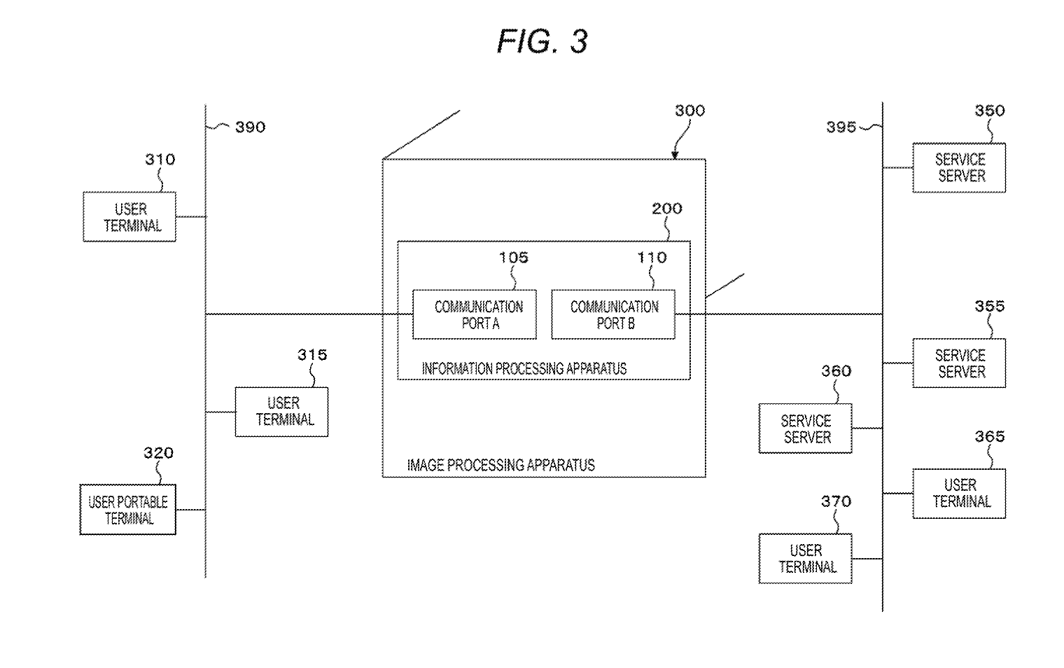

The communication port B 110 performs communication with a second device connected to a second communication line different from the first communication line. The first device and the second device may be any type of device if the devices are made communicable. The first device and the second device include, for example, a user terminal 310 such as a notebook PC, a user portable terminal 320 such as a tablet type portable terminal device, a service server 360 that performs a translation service, or the like, as will be described later with reference to FIG. 3.

In the following description, although the first device performs a request for processing (also referred to as Job) with respect to the second device, the second device performs the processing, a result of the processing is transmitted from the second device to the first device, and the request and the processing may be inversely performed between the first device and the second device.

In a case where the communication port A 105 receives a request for processing from the first device and the request for the processing is suitable for a condition for transmission to the second communication unit, the transmission/reception data control module 115 adds a piece of identification information identifying the processing to the request and transmits the request to the second device using the communication port B 110.

Next, the transmission/reception data control module 115 performs control such that the piece of identification information and the communication port A 105 are correlated with each other and are stored in the storage module 140. The transmission/reception data control module 115 controls, for example, data within a processing and transmission source correspondence table 500 which will be described later using an example of FIG. 5.

In a case where the result of the processing to which a piece of identification information is added is received from the second device, the transmission/reception data control module 115 extracts a communication port (any of the communication port A 105, and the communication port B 110) correlated with the piece of identification information using the storage module 140 and transmits the result of the processing to the first device using the communication port.

The transmission/reception data control module 115 may perform change control such that the request for processing is able to be received by the second device.

In a case where the second device requires, for example, additional data in performing the processing requested from the first device, the second device needs to perform communication to the first device. In order to make it possible to respond to the communication, the transmission/reception data control module 115 performs the following processing.

In a case where the communication port A 105 receives a request for processing from the first device, the transmission/reception data control module 115 adds a piece of identification information identifying the processing to the request and transmits the request to the second device using the communication port B 110.

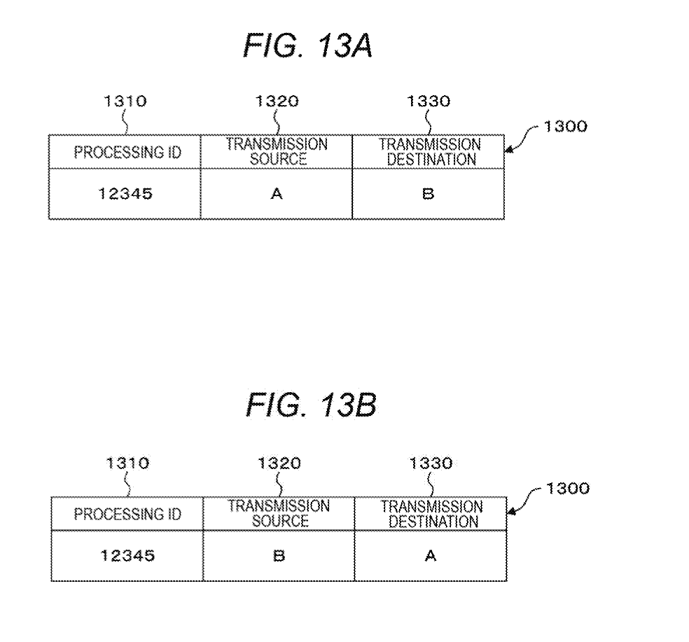

Next, the transmission/reception data control module 115 performs control such that the piece of identification information and the communication port A 105 of a transmission source and the communication port B 110 of a transmission destination are correlated with each other and are stored in the storage module 140 (storage control A). The transmission/reception data control module 115 controls, for example, data within a processing, transmission source and transmission destination correspondence table 1300 which will be described later using an example of FIG. 13.

Next, in a case where a request regarding the processing and added with a piece of identification information is received from the second device, the transmission/reception data control module 115 extracts a communication port of the transmission source (any of the communication port A 105, the communication port B 110) correlated with the piece of identification information using the storage module 140 and transmits the request to the first device using the communication port. Here, the request is for requesting, for example, additional data required for performing the processing by the second device.

The transmission/reception data control module 115 performs control such that the communication port B 110 as a transmission source correlated with the piece of identification information within the storage module 140 and the communication port A 105 as the transmission destination correlated with the piece of identification information within the storage module 140 are stored in the storage module 140 (storage control B). That is, in the storage control B, the transmission source and the transmission destination are inversed with each other compared to those of the processing in the storage control A. Specifically, in the storage control B, the communication port A 105 stored as the transmission source in the storage control A is stored as the transmission destination, and the communication port B 110 stored as the transmission destination in the storage control A is stored as the transmission source.

In a case where a request regarding the processing and added with a piece of identification information (piece of information which is a reply for the request) is received from the first device, the transmission/reception data control module 115 may extract a communication port of the transmission source (any of the communication port A 105, the communication port B 110) correlated with the piece of identification information using the storage module 140 and transmit the request regarding the processing to the second device using the communication port.

The transmission/reception data control module 115 may notify the result of the processing to a notification destination of a requester in a case where the communication port A 105 receives a request for processing and the notification destination. Here, the notification may include, for example, a notification using an e-mail, chatting, electronic bulletin board, social media, a push notification or the like. In a case of using the e-mail, the mail transmission module 130 may be used.

The transmission/reception data control module 115 may perform processing to be performed by the information processing apparatus 100 or predetermined processing in a case where the result of the processing added with the piece of identification information and the processing are received from the second device or the predetermined processing exists.

In a case where a request for processing is suitable for a condition in which a processing request is able to be transmitted from the first communication line to the second communication line (in a case where it is determined, by the data transmission propriety determination module 125, that the request is suitable for the condition), the Web UI control module 120 transmits a name of the processing provided by the second device to the first device and receives the name. The transmission and reception is performed using the Web UI function. Specifically, the Web UI function includes presenting the name of the processing to a Web page, replying to a “request for a name of a service capable of being used by the first device (a user who uses the first device)” from the first device, or the like.

The data transmission propriety determination module 125 determines whether a request for processing is suitable for a condition in which a processing request is able to be transmitted from one communication line to the other communication line. The condition described above includes, for example, a temporal restriction condition and a condition using user qualification, or the like. Specifically, the temporal restriction condition may include processing during a lunch time period from 12 O'clock to 13 O'clock. The processing during a lunch time period corresponds to a condition in which private use is permitted. The user qualification may include a case where a user identification (ID), a group ID, a password number (also generally referred to as a PIN code) or the like is coincident with a predetermined ID, or the like.

The mail transmission module 130 transmits an e-mail to the user according to control by the transmission/reception data control module 115. For example, the mail transmission module 130 transmits a processing result to the user who requests the processing as an e-mail.

The user interface module 135 presents a piece of information to the user of the information processing apparatus 100 or receives an operation of the user. As will be described using the example of FIG. 3 later, the user interface module 135 is for using the image processing apparatus 300 by the user. The user interface module 135 includes, for example, a display device such as a liquid crystal device, and an output device such as a speaker, a mouse, a keyboard, a touch panel, a reception device receiving the operation of the user using voice, line-of-sight, gesture, or the like.

The storage module 140 stores a processing management table 145, a processed data 150, a service list provided for each port 155, and a recipient table 160.

The processing management table 145 includes, for example, a processing and transmission source correspondence table 500. FIG. 5 is an explanatory diagram illustrating an example of a data structure of the processing and transmission source correspondence table 500. The processing and transmission source correspondence table 500 includes a processing ID field 510 and a transmission source field 520. The processing ID field 510 stores a piece of information (processing ID) for uniquely identifying the processing in the exemplary embodiment. The transmission source field 520 stores a transmission source that requests the processing. The processing ID is generated by the transmission/reception data control module 115. For example, the processing ID may be generated by being added with a serial number sequentially or may be generated in a random sequence. The transmission source is a device performing a processing request (first device in the above-described example). A device ID identifying the device, an IP address or the like may be used as the piece of information stored in the transmission source field 520. The piece of information may be a communication port ID identifying the communication port.

The processing management table 145 includes, for example, a processing, transmission source and transmission destination correspondence table 1300. FIG. 13 is an explanatory diagram illustrating an example of a data structure of the processing, transmission source and transmission destination correspondence table 1300. The processing, transmission source and transmission destination correspondence table 1300 includes a processing ID field 1310, a transmission source field 1320, and a transmission destination field 1330. The transmission destination field 1330 may be added to the processing and transmission source correspondence table 500. The processing ID field 1310 stores the processing ID. The transmission source field 1320 stores a transmission source that requests the processing. The transmission destination field 1330 stores a transmission destination that performs the processing. The transmission destination is a device that performs the processing in response to the processing request. The device ID identifying the device, the IP address or the like may be used for the piece of information to be stored in the transmission source field 1320.

In the storage control A, as illustrated in the example of FIG. 13A, a device (A) of the transmission source that requests the processing is stored in the transmission source field 1320 and a device (B) that performs the processing is stored in the transmission destination field 1330. In the storage control B described above, as illustrated in the example of FIG. 13B, the device (B) of the transmission source that requests regarding the processing is stored in the transmission source field 1320 and the device (A) that is the transmission destination for the request is stored in the transmission destination field 1330. That is, in the example of FIG. 13A and the example of FIG. 13B, the contents stored in the transmission source field 1320 may be exchanged with the contents stored in the transmission destination field 1330.

The processed data 150 includes the processing result by the second device, the processing result by the information processing apparatus 100 itself or the like.

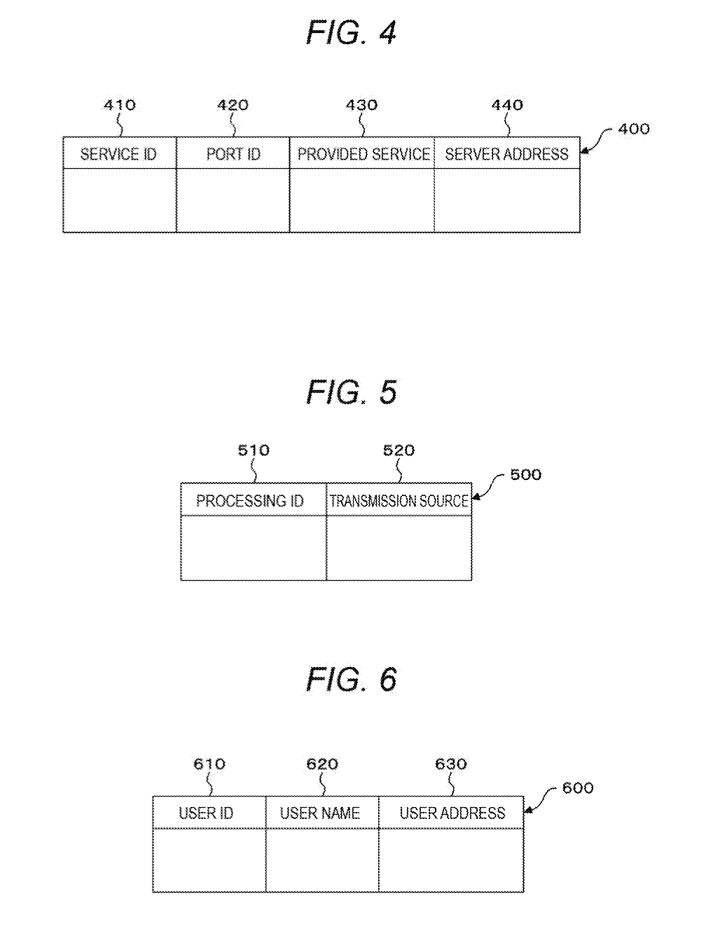

The service list provided for each port 155 is a list of services provided to each communication port by the device. The service list provided for each port 155 includes, for example, a port ID and provided service correspondence table 400. FIG. 4 is an explanatory diagram illustrating an example of a data structure of a port ID and provided service correspondence table 400. The port ID and provided service correspondence table 400 includes a service ID field 410, a port ID field 420, a provided service field 430, and a server address field 440. The service ID field 410 stores a piece of information (service ID) for uniquely identifying a service in the exemplary embodiment. The port ID field 420 stores a piece of information (port ID) for uniquely identifying a communication port to which the device for providing the service is connected in the exemplary embodiment. In the example of FIG. 1, the piece of identification information of any of the communication port A 105 and the communication port B 110 is stored. The provided service field 430 stores a name of the provided service. The server address field 440 stores an address (server address) of the device that provides the service.

The recipient table 160 corresponds to data that manages an address of a user or the like. The recipient table 160 includes, for example, an address table 600. FIG. 6 is an explanatory diagram illustrating an example of a data structure of an address table 600. The address table 600 includes a user ID field 610, a user name field 620, and a user address field 630. The user ID field 610 stores a piece of information (user ID) for uniquely identifying the user. The user name field 620 stores a user name of the user. The user address field 630 stores a user address of the user. The user address may include, for example, a notification destination in a type of notification using an e-mail, chatting, electronic bulletin board, social media, a push notification or the like, in addition to the e-mail address.

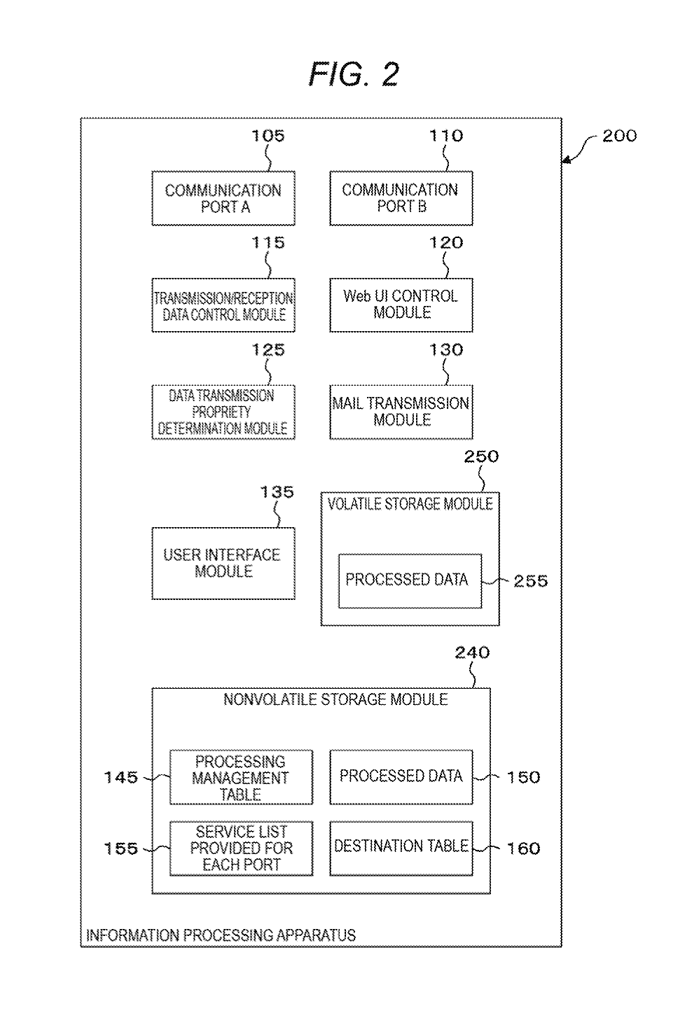

FIG. 2 is a configuration diagram conceptually illustrating modules in an example of a configuration of the exemplary embodiment. In the information processing apparatus 200, the storage module 140 of the information processing apparatus 100 illustrated in the example of FIG. 1 is divided into a nonvolatile storage module 240 and a volatile storage module 250. The same types of components as those of the information processing apparatus 100 illustrated in FIG. 1 are denoted by the same reference numerals and redundant descriptions thereof will not be repeated.

The information processing apparatus 200 includes the communication port A 105, the communication port B 110, the transmission/reception data control module 115, the Web UI control module 120, the data transmission propriety determination module 125, the mail transmission module 130, the user interface module 135, a nonvolatile storage module 240, and a volatile storage module 250.

The volatile storage module 250 stores the processed data 255. The volatile storage module 250 is configured by the random access memory (RAM) and stores pieces of information, which may be erased when a power supply is disconnected, of the processed data 150. Specifically, the pieces of information include pieces of information in a state of being subjected to processing or the like.

The nonvolatile storage module 240 stores the processing management table 145, the processed data 150, the service list provided for each port 155, and the recipient table 160. The nonvolatile storage module 240 is configured by a hard disk, a flash memory or the like, and stores, for example, pieces of information that are not erased when a power supply is disconnected, of the processed data 150. Even in a case where a power supply is disconnected during processing, the piece of information within the nonvolatile storage module 240 is used to resume the processing after the power is supplied.

FIG. 3 is an explanatory diagram illustrating an example of a configuration of a system using the exemplary embodiment.

The image processing apparatus 300 includes the information processing apparatus 200 and is any of a copy machine, a facsimile, a scanner, a printer, a multifunction machine (image processing apparatus equipped with functions of two or more of a scanner, a printer, a copy machine, a facsimile or the like).

The information processing apparatus 200 includes the communication port A 105 and the communication port B 110 and is connected to two communication lines (communication line A 390 and communication line B 395), as described above. The communication line A 390 and the communication line B 395 may be a wired communication network, a wireless communication network, or a combination of the wired communication network and the wireless communication network, and may be, for example, the Internet and the Ethernet as communication infrastructure.

The communication port A 105 is connected to the communication line A 390. The communication port A 105 is connected to the user terminal 310, the user terminal 315, and the user portable terminal 320 through the communication line A 390.

The communication port B 110 is connected to the communication line B 395. The communication port B 110 is connected to the service server 350, the service server 355, the service server 360, the user terminal 365, and the user terminal 370 through the communication line B 395. In this example, the function of the service server 350, that is a processing apparatus, or the like may be implemented by a cloud service.

The communication port A 105 and the communication port B 110 are connected to the communication line A 390 and the communication line B 395, that are independent of each other, to be operated. For example, the communication port A 105 and the communication port B 110 may be connected to communication lines that are divided for each user or each usage as in the in-house network and the visitor network in a company, the employ network and the customer network in a shop, the teacher network and the student network in a school, or the like.

The image processing apparatus 300 provided with plural communication ports performs control, from the viewpoint of security such that data to be transmitted to and received from respective communication lines are separately handled and the data do not output to different communication lines.

However, in this case, in the image processing apparatus not having the function of the information processing apparatus 100 (information processing apparatus 200), in a case where there is a function or a service which is unable to use only one communication line, a user who uses the other communication line is not able to use the one communication line. Therefore, it is necessary to ask a user, who belongs to the communication line side in which the function is able to be implemented, to execute a Job and, it is inefficient.

In particular, in the techniques disclosed in the Patent Documents described in the above, in a case where a user who belong to the other communication line wants to use a function of using a server or cloud that is accessible only by one communication line, it is unable for the image processing apparatus to receive any processing result after the data are transmitted to the server and reply the processing result to the user. That is, in the techniques described in the Patent Documents, the data transfer from the one communication port to the other communication port is securely executed only and accordingly, the processing result of a service of the other communication port side is not able to be replied to the user.

The image processing apparatus 300 makes it possible for the user who belongs to the other communication line to use the service or the like able to be used only by the one communication line. Here, the use refers that a request for processing can be made and a result of the processing can be obtained. In the example of FIG. 3, although the service provided by the service server 350 is generally able to be used only by the user terminal 365 or the like connected to the same communication line B 395, the user terminal 310 or the like connected to the communication line A 390 also becomes able to use the service provided by the service server 350 by the image processing apparatus 300.

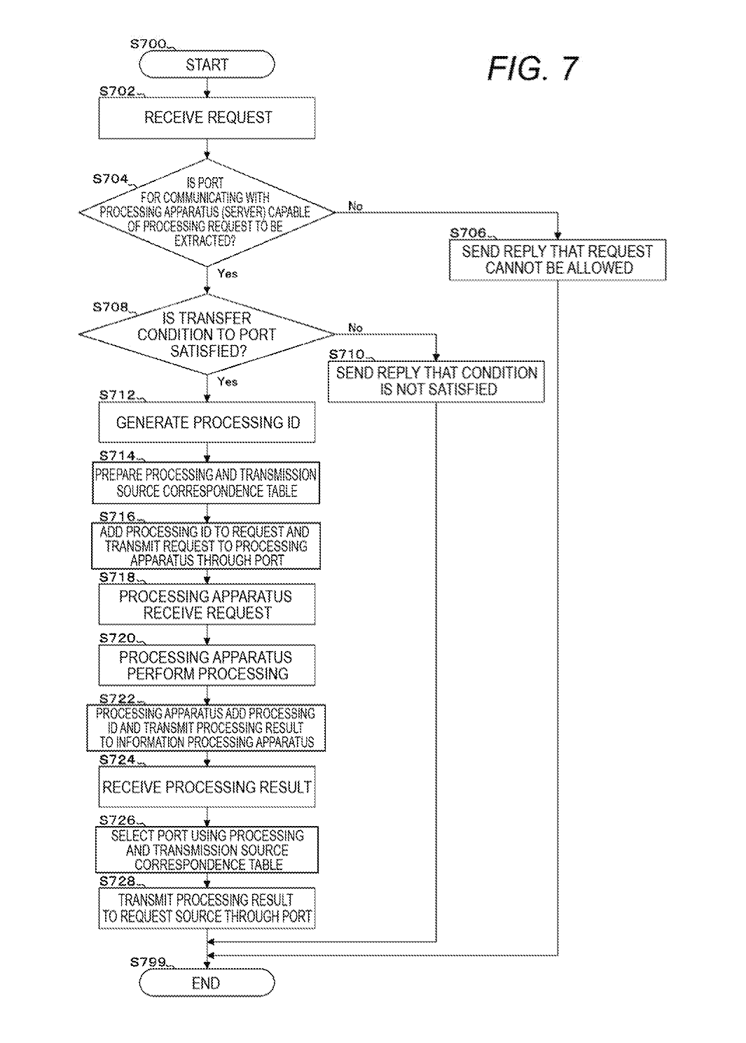

FIG. 7 is a flowchart illustrating an example of a process performed by the exemplary embodiment.

In Step S702, the transmission/reception data control module 115 receives a request for processing from a device.

In Step S704, the transmission/reception data control module 115 determines whether a communication port for communicating with a processing apparatus (server) capable of processing the request is to be extracted. When it is determined that the communication port is to be extracted, the process proceeds to Step S708 and otherwise, the process proceeds to Step S706. The determination in Step S704 is to determine whether the requested processing is able to be implemented by the processing apparatus within the communication line connected to the information processing apparatus 200. Specifically, it may be determined according to whether the requested processing is present in the port ID and provided service correspondence table 400.

In Step S706, the transmission/reception data control module 115 sends a reply that the request cannot be allowed, and ends the process (Step S799).

In Step S708, the data transmission propriety determination module 125 determines whether a transfer condition to the communication port is satisfied or not. When it is determined that the condition is satisfied, the process proceeds to Step S712 and otherwise, the process proceeds to Step S710. The determination in Step S708, as described above, is to determine whether a request for processing is suitable for the condition, for example, the temporal restriction condition and the condition using user qualifications.

In Step S710, the transmission/reception data control module 115 sends a reply that the transfer condition is not satisfied, and ends the process (Step S799).

In Step S712, the transmission/reception data control module 115 generates a processing ID.

In Step S714, the transmission/reception data control module 115 prepares the processing and transmission source correspondence table 500 in the nonvolatile storage module 240.

In Step S716, the transmission/reception data control module 115 adds the processing ID to the request and transmit the request to the processing apparatus through the communication port. For example, the transmission/reception data control module 115 transmits the request for processing received by the communication port A 105 to the processing apparatus through the communication line connected to the communication port B 110. The request for processing is added with the processing ID.

In this case, the transmission/reception data control module 115 may perform the following processing.

The request may be modified to be transmitted from the user terminal 365 or the like connected to the communication line B 395 and thus, the processing is received in the service server 350. Specifically, the piece of identification information (an IP address or the like, as an example) of the request source apparatus included in the request may be changed into the piece of identification information of the user terminal 365 or the like connected to the communication line B 395 or may be changed into the piece of identification information of the image processing apparatus 300 itself. In a case where the condition in which the request is received in the service server 350 is based on the piece of identification information of a valid user in the communication line B 395, the piece of identification information (a user identifier or an identifier of an organization to which the user belongs or the like, as an example) of the request source user included in the request may be changed into an identifier of the valid user in the communication line B 395. The identifier of the valid user in the communication line B 395 may be stored in the nonvolatile storage module 240 by the image processing apparatus 300 and the image processing apparatus 300 retrieves a user management server (LDAP server as an example), which is not illustrated, to acquire an identifier of the user and changes the identifier included in the request into the acquired identifier of the user. In this case, the example of the retrieval condition for the user management server may include a temporal identifier for the user for the request transmitted from the communication line A 390. In a case where the condition in which the request is received in the service server 350 is based on the piece of identification information of a valid user in the communication line B 395, the piece of identification information of the request source user may be changed into the piece of identification information (identification information of a role given to the user, identification information of a role given to the image processing apparatus 300 or the like, as an example) of a role of the request source included in the request. The role referred to herein, as an example, may be obtained by collecting single authority or a plurality of authorities capable of utilizing a device or a service and giving the piece of identification information to the single authority or the plurality of authorities capable of utilizing the device or the service, and the piece of authority information collected to the role may be collectively given to a target to which the role is given (the target may be a user or a device). Similar to the example of the piece of identification information of the user, the piece of the identification information of the role may be stored in the nonvolatile storage module 240 of the image processing apparatus 300 or may be acquired by being retrieved by the user management server not illustrated. In this case, the example of the retrieval condition for the user management server may include a temporal identifier for the role for the request transmitted from the communication line A 390. The change of the request may include addition of the piece of identification information to the request.

In the request, in a case where the piece of identification information of the apparatus, the piece of identification information of the user, or the piece of identification information of the role is changed or added to, the respective pieces of identification information that are changed or added to may be stored in the processing and transmission source correspondence table 500 in correlation with the transmission source of the request.

In Step S718, the processing apparatus receives the request.

In Step S720, the processing apparatus performs the processing.

In Step S722, the processing apparatus adds the processing ID and transmits the processing result to the information processing apparatus 200.

In Step S724, the transmission/reception data control module 115 receives the processing result. The processing result is added with the processing ID.

In Step S726, the transmission/reception data control module 115 selects the port using the processing and transmission source correspondence table 500. Specifically, the transmission/reception data control module 115 extracts the transmission source, which is correlated with the processing ID which is added to the processing result, from the processing and transmission source correspondence table 500 and selects the communication port to which the transmission source is connected.

In Step S728, the transmission/reception data control module 115 transmits the processing result to the request source through the communication port.

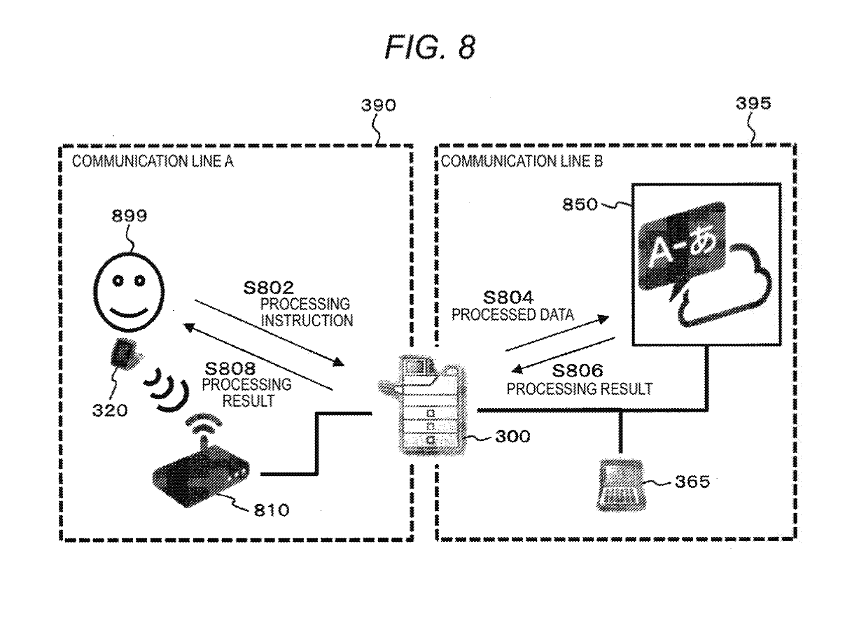

FIG. 8 is an explanatory diagram illustrating an example of a process performed by the exemplary embodiment. In the example of FIG. 8, the image processing apparatus 300 includes two communication ports, the communication line A 390, and the communication line B 395. In the communication line A 390, the user 899 requests translation processing using the user portable terminal 320. The processing apparatus capable of performing the translation processing is not present in the communication line A 390, however, a translation server 850 is present in the communication line B 395. For example, the communication line A 390 is a visitor network and the communication line B 395 is an in-house network. The communication port A 105 is connected to the communication line A 390 and the communication port B 110 is connected to the communication line B 395.

In Step S802, a user 899 instructs the image processing apparatus 300 to perform the translation processing.

In Step S804, the image processing apparatus 300 transmits a processing instruction (including processed data that is a translation target) to the translation server 850.

In Step S806, the translation server 850 transmits the processing result (translated result) to the image processing apparatus 300.

In Step S808, the image processing apparatus 300 transmits the processing result (translated result) to the user 899.

When the processing result (translated result) is transmitted from the image processing apparatus 300 to the user 899, the respective pieces of identification information, which are changed or added when the request is transmitted to the processing apparatus, may be extracted from the processing and transmission source correspondence table 500 on the basis of the transmission destination and an unnecessary piece of identification information of the extracted pieces of identification information may be deleted or replaced with the original piece of identification information.

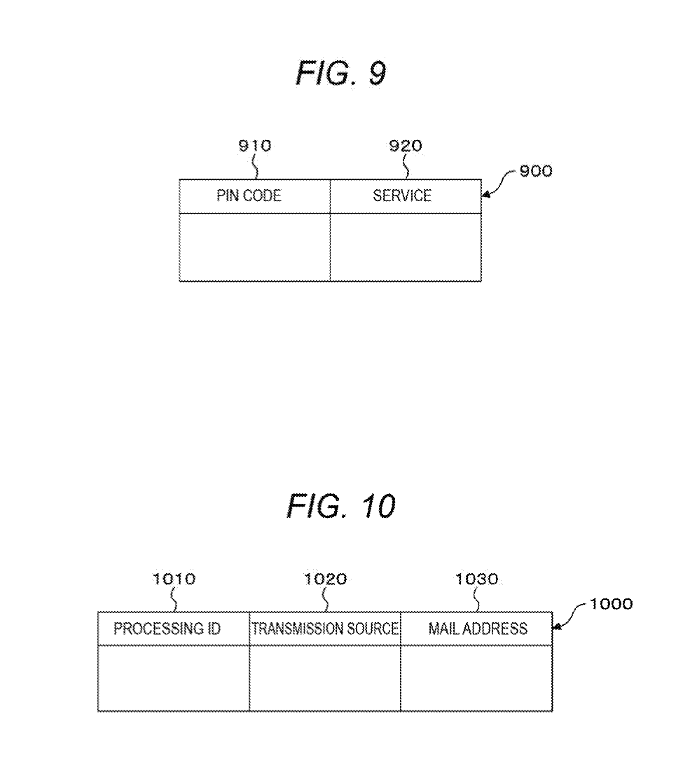

The image processing apparatus 300 (Web UI control module 120) is equipped with a Web UI function and may be equipped with a function of displaying an execution screen of the processing capable of being executed using the communication line B 395 of the communication port B 110 in a case where the condition in which the processed data is able to be transmitted from the communication port A 105 to the communication port B 110 is arranged when the user 899 in the communication port A 105 side accesses the Web UI. In this case, input of a PIN code or the like for permission of transmission may be requested. That is, a password number may be requested in order to utilize the service and only the user 899 who knows a password number is able to utilize the service. For such a determination, for example, a PIN code and service correspondence table 900 may be used. FIG. 9 is an explanatory diagram illustrating an example of a data structure of the PIN code and service correspondence table 900. The PIN code and service correspondence table 900 includes a PIN code field 910 and a service field 920. The PIN code field 910 stores a PIN code necessary for utilizing a service of the service field 920. The service field 920 stores a service.

In a case where the image processing apparatus 300 receives an execution result of the processing from the communication port B 110 side, when the execution result is a result by the processing instruction from the communication port A 105, the result may be displayed on the Web UI of the communication port A 105 side.

Furthermore, the image processing apparatus 300 may use a corresponding printer driver or application (so-called smart phone application or the like) and returns a list of the “executable processing using the communication line B 395 of the communication port B 110” and the “executable processing by the communication line A 390 of the communication port A 105” to the user portable terminal 320 in a case where the condition in which the processed data is able to be transmitted from the communication port A 105 to the communication port B 110 is arranged when an inquiry about the function capable of being provided is received from the user portable terminal 320 of the communication port A 105 side and thus, functions capable of being selected by the printer driver or the like may be displayed. In this case, as described above, input of a PIN code or the like for permitting transmission may be requested.

In the image processing apparatus 300, in a case where the mail address is added to the processing instruction, the processing ID and the mail address are managed in correlation with each other. When the execution result is received from the communication port B 110 side, the processing result may be transmitted by an e-mail using the communication line A 390 of the communication port A 105 with respect to the mail address. The mail address may be managed using, for example, a processing, transmission source and mail address correspondence table 1000. FIG. 10 is an explanatory diagram illustrating an example of a data structure of the processing, transmission source and mail address correspondence table 1000. The processing, transmission source and mail address correspondence table 1000 is obtained by adding a mail address field 1030 to the processing and transmission source correspondence table 500. The processing, transmission source and mail address correspondence table 1000 includes a processing ID field 1010, a transmission source field 1020, and a mail address field 1030. The processing ID field 1010 stores the processing ID. The transmission source field 1020 stores the transmission source. The mail address field 1030 stores the mail address added to the processing instruction.

Furthermore, in the image processing apparatus 300, in a case where the processing instruction is added with the piece of user information, the processing identifier and the piece of user information are managed in correlation with each other. When the execution result of the processing is received from the communication port B 110 side, the mail address of the user may be acquired and the processing result may be transmitted by the e-mail using the communication line A 390 of the communication port A 105. The user and the mail address may be managed in correlation with each other using, for example, the address table 600. For managing the processing identifier and the user in correlation with each other, for example, the mail address field 1030 of the processing, transmission source and mail address correspondence table 1000 illustrated in FIG. 10 may be used as a field for storing an user ID.

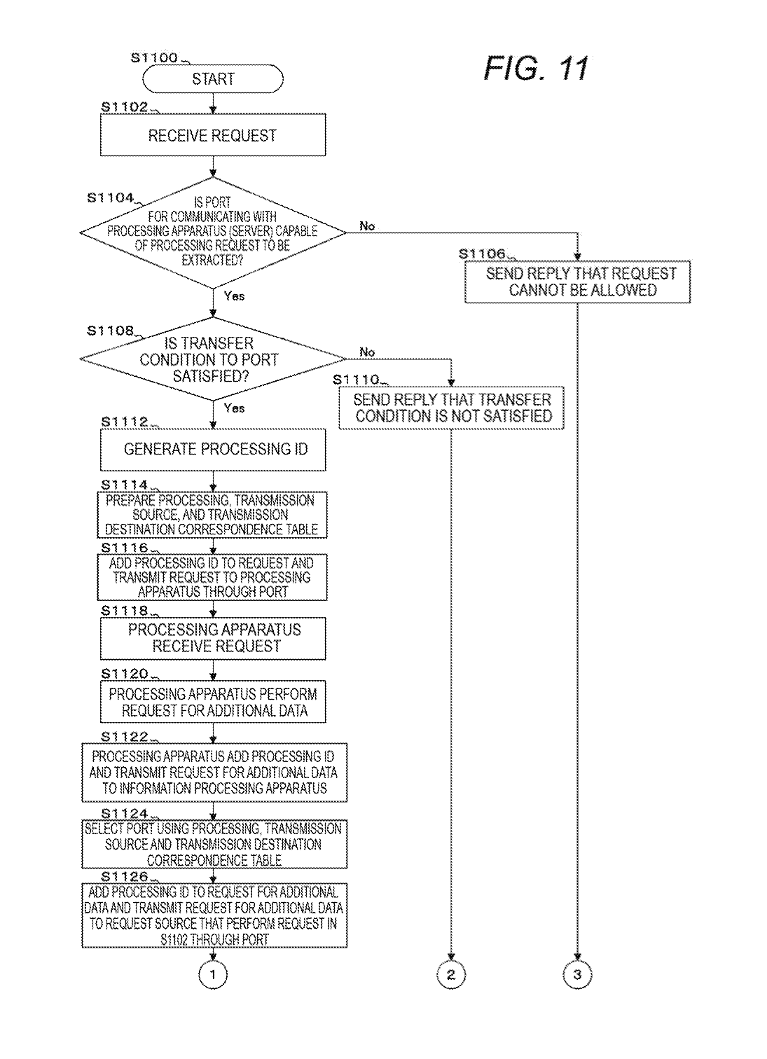

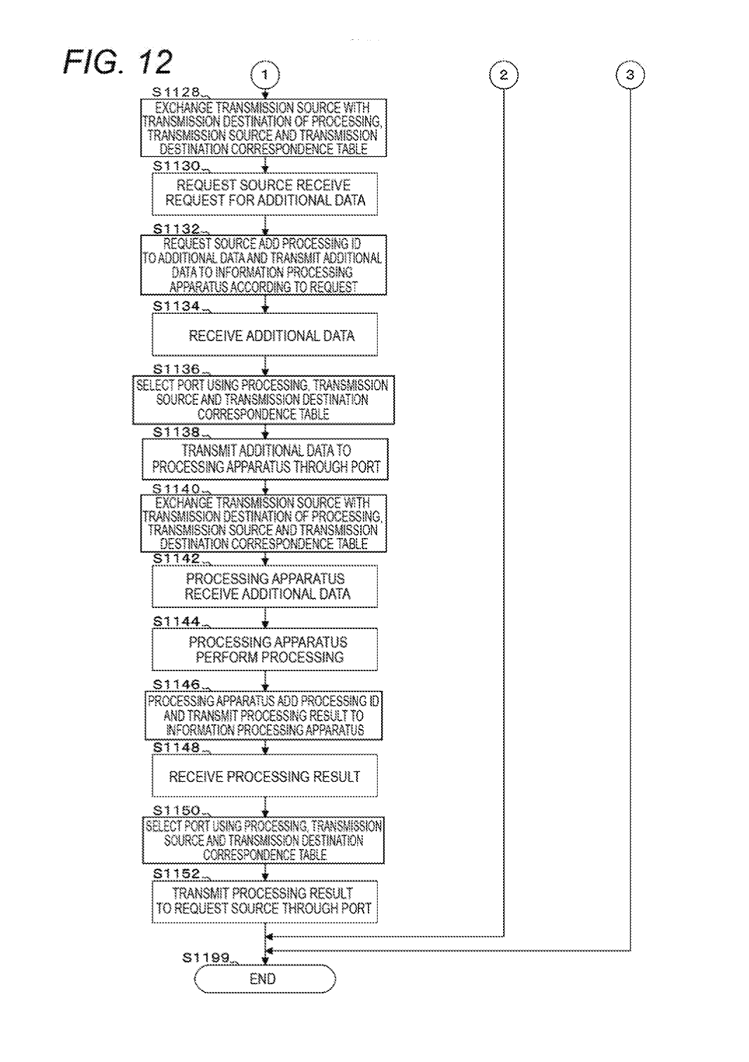

FIG. 11 and FIG. 12 are flowcharts illustrating an example of a process performed by the exemplary embodiment. The flowchart illustrated in the example of FIG. 7 corresponds to a process spanning from processing of performing a request for processing to processing of obtaining the processing result. However, the flowcharts illustrated in the examples of FIG. 11 and FIG. 12 correspond to a process spanning from the processing, in which the processing apparatus requests the piece of additional data necessary for the processing to the transmission source, to the processing in which the processing apparatus transmits the processing result after additional piece of data is obtained from the processing apparatus. The processing spanning from Step S1102 to Step S1112 is equivalent to those from Step S702 to Step S712 illustrated in the example of FIG. 7.

In Step S1102, the transmission/reception data control module 115 receives a request.

In Step S1104, the transmission/reception data control module 115 determines whether a communication port for communicating with the processing apparatus (server) capable of processing the request is to be extracted. When it is determined that the communication port is to be extracted, the process proceeds to Step S1108 and otherwise, the process proceeds to Step S1106.

In Step S1106, the transmission/reception data control module 115 sends a reply that the request cannot be accepted allowed, and ends the process (Step S1199).

In Step S1108, the data transmission propriety determination module 125 determines whether the transfer condition to the port is satisfied or not. When the transfer condition to the port is satisfied, the process proceeds to Step S1112 and otherwise, the process proceeds to Step S1110.

In Step S1110, the transmission/reception data control module 115 sends a reply that the transfer condition is not satisfied, and ends the process (Step S1199).

In Step S1112, the transmission/reception data control module 115 generates the processing ID.

In Step S1114, the processing, transmission source and transmission destination correspondence table 1300 is prepared. A transmission destination field 1330 is different from the processing and transmission source correspondence table 500 in Step S714 of the flowchart illustrated in the example of FIG. 7. That is, the processing and transmission source correspondence table 500 includes not only a transmission source but also a transmission destination.

In Step S1116, the transmission/reception data control module 115 adds the processing ID to the request and transmit the request to the processing apparatus through the port. The processing of Step S1116 is equivalent to the processing of Step S716 of the flowchart illustrated in the example of FIG. 7.

In Step S1118, the processing apparatus receives the request. The processing of Step S1118 is equivalent to the processing of Step S718 of the flowchart illustrated in the example of FIG. 7.

In Step S1120, the processing apparatus perform a request for additional data. The request for additional data is for requesting the additional data needed for performing the request processing for the transmission source.

In Step S1122, the processing apparatus adds the processing ID to the request and transmits the request for additional data to the information processing apparatus 200.

In Step S1124, the port is selected using the processing, transmission source and transmission destination correspondence table 1300. Specifically, the contents of the transmission source field 1320 of the processing, transmission source and transmission destination correspondence table 1300 may be extracted.

In Step S1126, the processing ID is added to the request for additional data and the request is transmitted to the request source that performs the request at S1102.

In Step S1128, the transmission/reception data control module 115 exchanges the transmission source with the transmission destination of the processing, transmission source and transmission destination correspondence table 1300. As described above, the contents of the transmission source field 1320 may be exchanged with the contents of the transmission destination field 1330 as illustrated in FIG. 13A and FIG. 13B.

In Step S1130, the request source receives the request for additional data.

In Step S1132, the request source adds the processing ID to additional data and transmits the additional data to the information processing apparatus 200.

In Step S1134, the transmission/reception data control module 115 receives the additional data.

In Step S1136, the port is selected using the processing, transmission source and transmission destination correspondence table 1300. Specifically, the contents of the transmission source field 1320 of the processing, transmission source and transmission destination correspondence table 1300 may be extracted.

In Step S1138, the additional data is transmitted to the processing apparatus through the port.

In Step S1140, the transmission/reception data control module 115 exchanges the transmission source with the transmission destination of the processing, transmission source and transmission destination correspondence table 1300.

In Step S1142, the processing apparatus receives the additional data.

In Step S1144, the processing apparatus performs the processing.

In Step S1146, the processing apparatus adds the processing ID and transmits the processing result to the information processing apparatus 200.

In Step S1148, the transmission/reception data control module 115 receives the processing result.

In Step S1150, the transmission/reception data control module 115 selects the port using the processing, transmission source and transmission destination correspondence table 1300.

In Step S1152, the transmission/reception data control module 115 transmits the processing result to the request source through the port.

The processed data allowed to be transmitted from the communication port A 105 to the communication port B 110 (may also be reversely transmitted) may be repeatedly reciprocated, and checking (processing in Step S1104 and Step S1108) as to whether the transmission is allowed or not is not performed.

The Web UI or the like as described above may be used also in the process illustrated in the examples of FIG. 11 and FIG. 12. In a case where the information processing apparatus 200 obtains a request for additional data from the communication port B 110 side, when the obtained request corresponds to the request for the processing instructed from the communication port A 105, an additional request may be displayed on the Web UI of the communication port A 105.

In the process of the flowcharts illustrated in the examples of FIG. 7 or FIG. 11 and FIG. 12, when the processing result is received, the image processing apparatus 300 (information processing apparatus 200) may perform processing on the basis of a processing result processing method added to the processing result.

The processing result processing method may include, for example, the following processing. When the processing result is received, the processing result is printed out. The processing result is maintained in the storage device of the image processing apparatus 300 until the user, who issues the processing instruction, issues the print instruction. The processing result is notified to the user, who issues the processing instruction, by an e-mail. The processing result is able to be downloaded from the Web UI. The processing result is stored in a designated server.

The image processing apparatus 300 (information processing apparatus 200) may be able to set default processing (predetermined processing), which is to be performed when the processing result is received, for each communication port or for each type of the requested processing.

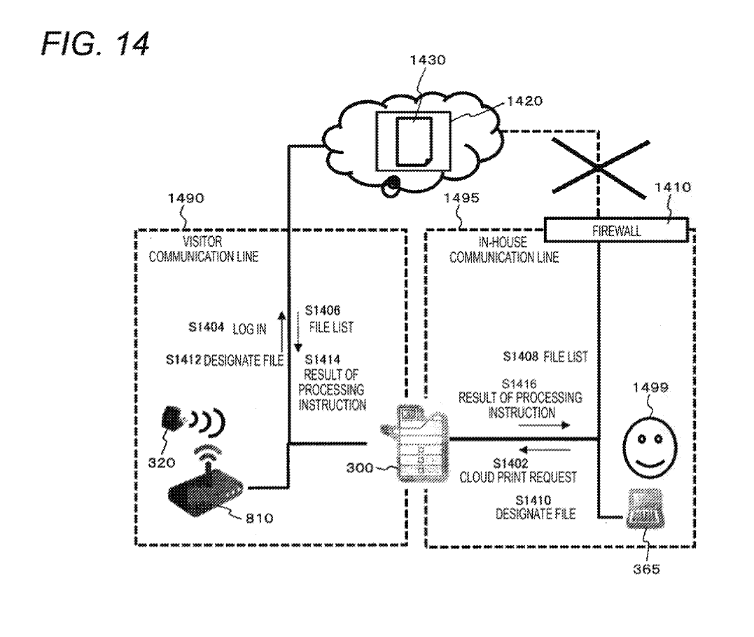

FIG. 14 is an explanatory diagram illustrating an example of the processing by the exemplary embodiment. In the example of FIG. 14, the image processing apparatus 300 includes two communication ports and a visitor communication line 1490 and an internal use communication line 1495 are respectively connected to the communication port A 105 and the communication port B 110.

An example in which the user 1499 who is an employee uses a cloud print processing apparatus 1420, which is an external cloud service, through the visitor communication line 1490 using the user terminal 365 is illustrated. A situation may exist where accessing the cloud print processing apparatus 1420 may be blocked by a firewall 1410 and thus the accessing from inside of the internal use communication line side 1495 is not allowed. However, it is set that connection to the visitor communication line 1490 and private printing in the image processing apparatus 300 is permitted during a lunch break period.

An example is illustrated in which the user 1499 accesses the cloud print processing apparatus 1420 using the user terminal 365 and prints out a private document 1430 in the cloud print processing apparatus 1420 by the image processing apparatus 300 during a lunch break.

In Step S1402, the user terminal 365 requests for the cloud print to the cloud print processing apparatus 1420 through the image processing apparatus 300 and the visitor communication line 1490.

In Step S1404, the user terminal 365 logs in to the cloud print processing apparatus 1420 through the image processing apparatus 300 and the visitor communication line 1490.

In Step S1406, the cloud print processing apparatus 1420 transmits a file list (including the document 1430) of the user 1499 to the image processing apparatus 300.

In Step S1408, the image processing apparatus 300 transmits the file list to the user terminal 365.

In Step S1410, the user terminal 365 designates a file to be printed and informs the file to the cloud print processing apparatus 1420 through the image processing apparatus 300 and the visitor communication line 1490.

In Step S1412, the image processing apparatus 300 informs the designated file to the cloud print processing apparatus 1420.

In Step S1414, the cloud print processing apparatus 1420 transmits the result of the processing instruction to the image processing apparatus 300.

In Step S1416, the image processing apparatus 300 notifies the result of the processing instruction to the user terminal 365. The image processing apparatus 300 receives the piece of data of the document 1430 to be printed out, prints the document 1430, and notifies the user terminal 365 that the document 1430 is printed.

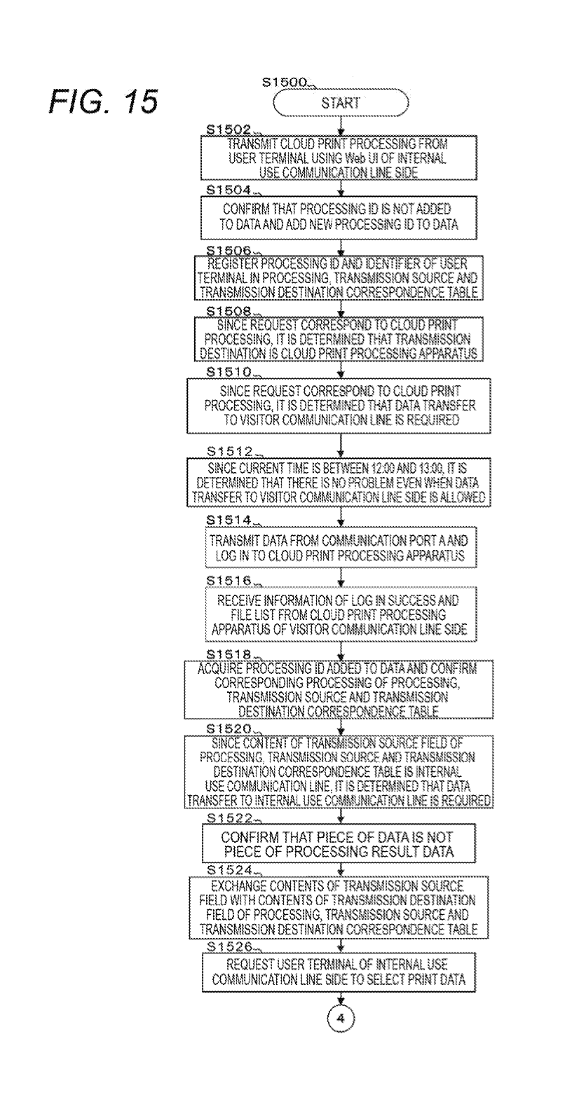

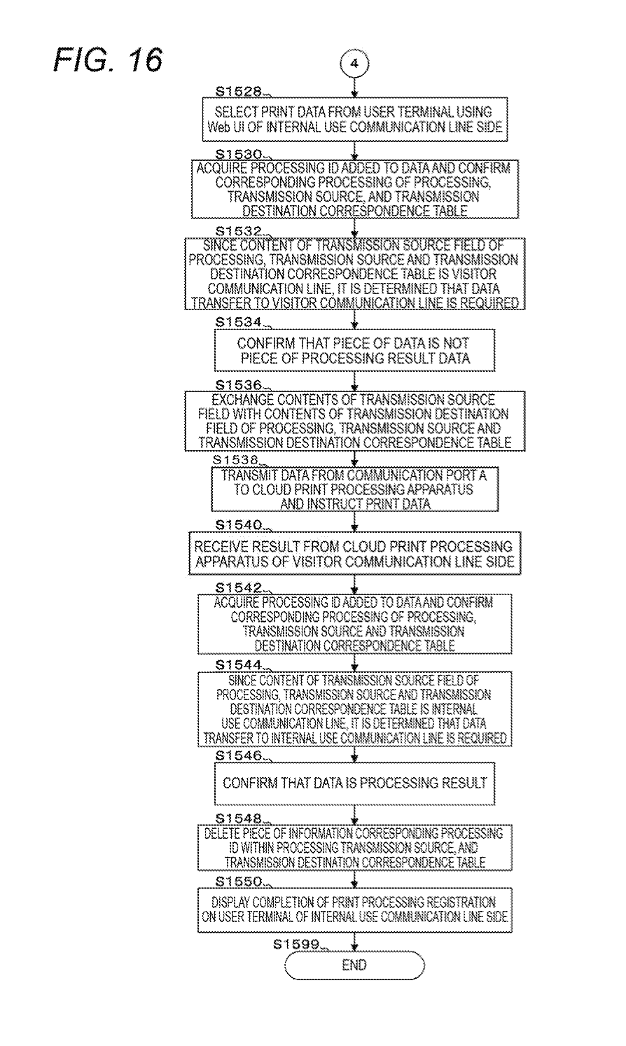

FIG. 15 and FIG. 16 are flowcharts illustrating an example of a process performed by the exemplary embodiment. The processing illustrated in the example of FIG. 14 will be described in more detail.

In Step S1502, a request for cloud print processing is transmitted from the user terminal 365 using the Web UI of the in-house communication line 1495 side. Specifically, the request for cloud print processing, the piece (account and password) of log in information of the user 1499 and the like are transmitted.

In Step S1504, it is confirmed that the processing ID is not added to the data, a new processing ID is generated, and the new processing ID is added to data.

In Step S1506, the processing ID and the identifier of the user terminal 365 are registered in the processing, transmission source and transmission destination correspondence table 1300.

In Step S1508, since the request corresponds to the cloud print processing, it is determined that the transmission destination is the cloud print processing apparatus 1420.

In Step S1510, since the request corresponds to the cloud print processing, it is determined that the data transfer to visitor communication line 1490 side is required.

In Step S1512, since current time is between 12:00 and 13:00, it is determined that there is no problem even when the data transfer to the visitor communication line 1490 side is allowed.

In Step S1514, data is transmitted from the communication port A 105 and login to cloud print processing apparatus 1420 is made.

In Step S1516, the piece of information of log in success and the file list are received from the cloud print processing apparatus 1420 of the visitor communication line 1490 side.

In Step S1518, the processing ID added to data is acquired and corresponding processing of the processing, transmission source and transmission destination correspondence table 1300 is confirmed.

In Step S1520, since the transmission source field 1320 of the processing, transmission source and transmission destination correspondence table 1300 is the internal use communication line 1495, it is determined that the data transfer to the internal use communication line 1495 is required.

In Step S1522, it is confirmed that the piece of data is not the piece of processing result data. In a case where the piece of data is not the piece of processing result data, the processing, transmission source and transmission destination correspondence table 1300 is maintained as it is.

In Step S1524, the contents of the transmission source field 1320 of the processing, transmission source and transmission destination correspondence table 1300 is exchanged with the contents of transmission destination field 1330.

In Step S1526, the user terminal 365 of the internal use communication line 1495 side is requested to select the print data.

In Step S1528, the print data is selected from the user terminal 365 using the Web UI of the internal use communication line 1495 side.

In Step S1530, the processing ID added to the data is acquired and the corresponding processing of the processing, transmission source and transmission destination correspondence table 1300 is confirmed.

In Step S1532, since the transmission source field 1320 of the processing, transmission source and transmission destination correspondence table 1300 is the visitor communication line 1490, it is determined that the data transfer to the visitor communication line 1490 is required.

In Step S1534, it is confirmed that the piece of data is not the piece of processing result data. In a case where the piece of data is not the piece of processing result data, the processing, transmission source and transmission destination correspondence table 1300 is maintained as it is.

In Step S1536, the contents of the transmission source field 1320 and the contents of the transmission destination field 1330 the processing, transmission source and transmission destination correspondence table 1300 are exchanged with each other.

In Step S1538, the data is transmitted from the communication port A 105 to the cloud print processing apparatus 1420 and the print data is instructed.

In Step S1540, the result (specifically, a registration result of the print processing) is received from the cloud print processing apparatus 1420 of the visitor communication line 1490 side.

In Step S1542, the processing ID added to the data is acquired and the corresponding processing of the processing, transmission source and transmission destination correspondence table 1300 is confirmed.

In Step S1544, since the transmission source field 1320 of the processing, transmission source and transmission destination correspondence table 1300 is the internal use communication line side 1495, it is determined that the data transfer to the internal use communication line side 1495 is required.

In Step S1546, it is confirmed that the data is the processing result. When the data is the processing result, the data exchange is completed and thus, the processing, transmission source and transmission destination correspondence table 1300 is deleted.

In Step S1548, the piece of information corresponding processing ID within the processing, transmission source and transmission destination correspondence table 1300 is deleted.

In Step S1550, the registration completion of the print processing is displayed on the user terminal 365 of the internal use communication line 1495 side. The printing itself is processing in a cloud print process by the cloud print processing apparatus 1420.

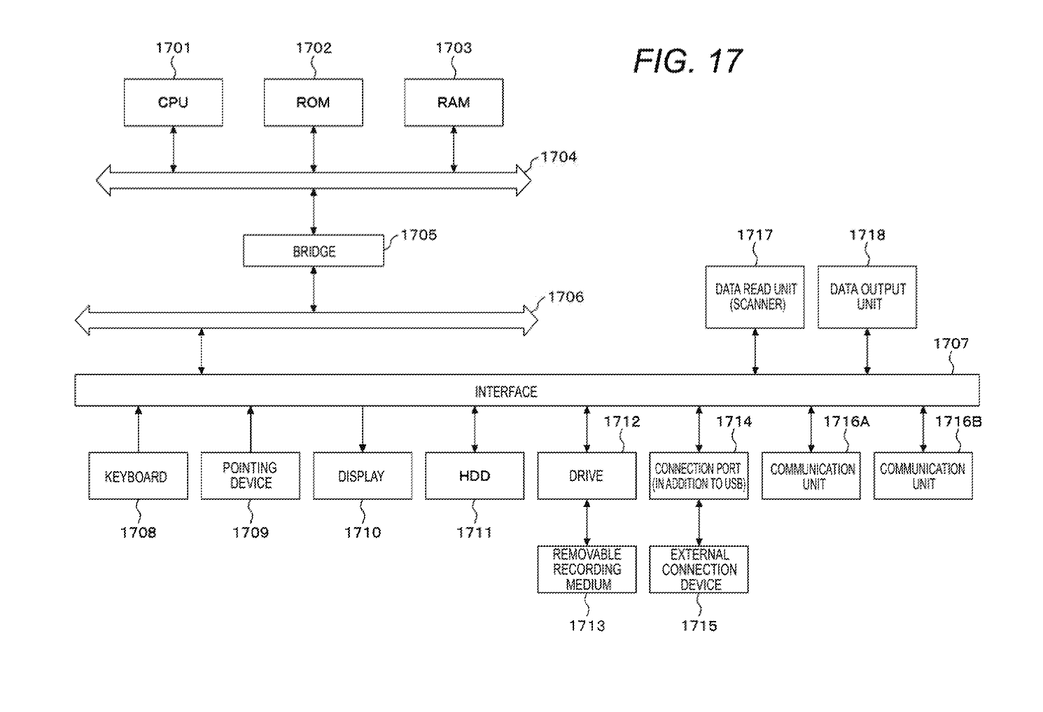

An example of a hardware configuration of a computer that implements the exemplary embodiment will be described with reference to FIG. 17. The configuration illustrated in FIG. 17 may be configured, for example, by a personal computer (PC) or the like, and illustrates an example of a hardware configuration provided with a data read unit 1717 such as a scanner and a data output unit 1718 such as a printer.

A central processing unit (CPU) 1701 is a control unit that executes processing on the basis of a computer program in which an execution sequence of various modules, that is, respective modules of the communication port A 105, the communication port B 110, the transmission/reception data control module 115, the Web UI control module 120, the data transmission propriety determination module 125, the mail transmission module 130, the user interface module 135 and the like, in the exemplary embodiment described above.

A read only memory (ROM) 1702 stores a program or operation parameters or the like used by the CPU 1701. A random access memory (RAM) 1703 stores a program used in execution by the CPU 1701 or parameters that are varied properly in the execution or the like, in addition to implementing the function as a volatile storage module 250. The ROM 1702, the RAM 1703, and the CPU 1701 are connected to each other by a host bus 1704 configured by a CPU bus or the like.

The host bus 1704 is connected to an external bus 1706 such as the peripheral component interconnect/interface (PCI) bus through a bridge 1705.

A pointing device 1709 such as a keyboard 1708 or a mouse is operated by an operator. The display 1710 includes a liquid crystal device, a cathode ray tube (CRT), or the like and displays various pieces of information as a piece of text information or a piece of image information. A touch screen equipped with functionalities of both the pointing device 1709 and the display 1710 or the like may be used.

A hard disk drive (HDD) 1711 has a hard disk (may also be a flash memory or the like) built therein, drives the hard disk, and records or reproduces the program executed by the CPU 1701 or the piece of information. The HDD 1711 implements the function as the storage module 140, the nonvolatile storage module 240, or the like. Furthermore, the HDD 1711 stores various data and computer programs in addition to the program executed by the CPU 1701 or the piece of information.

The drive 1712 reads the data or the program recorded in a removable recording medium 1713 such as a magnetic disk, an optical disk, a magnetooptical disk, or a semiconductor memory that are mounted, and supplies the data or the program read to the RAM 1703 connected thereto through the interface 1707, the external bus 1706, the bridge 1705, and the host bus 1704. The removable recording medium 1713 is also able to be used as a data recording area.

A connection port 1714 is for connecting the external connection device 1715 and is provided with a connection unit such as the USB and the IEEE1394. The connection port 1714 is connected to the CPU 1701 or the like through the interface 1707, the external bus 1706, the bridge 1705, the host bus 1704, or the like. The communication unit 1716 is made up of two communication units (communication unit 1716A and communication unit 1716B), is connected to the communication line to correspond to the communication port A 105 and the communication port B 110, and executes data communication processing with respective devices connected to the communication line. The communication unit 1716 may be made up of three or more communication units. A data read unit 1717 may include, for example, a scanner and executes document read processing. A data output unit 1718 may include, for example, a printer and executes document data output processing.

The hardware configuration of the information processing apparatus illustrated in FIG. 17 illustrates just one example of the configuration, the exemplary embodiment is not limited to the configuration illustrated in FIG. 17, and may be a configuration in which the modules described in the exemplary embodiment are adapted to be executable. For example, some of the modules may be configured by exclusive hardware (for example, an application specific integrated circuit (ASIC) or the like), some of the modules may be adapted to be connected by the communication line placed within an external system. Furthermore, plural systems illustrated in FIG. 17 may be connected to each other by the communication line to be cooperated with each other. In particular, the system may be incorporated into a portable information communication device (including a portable phone, a smart phone, a mobile device, a wearable computer or the like), a home information appliance, a robot, a copy machine, a facsimile, a scanner, a printer, a multifunction machine (image processing apparatus equipped with functionalities of two or more of a scanner, a printer, a copy machine, a facsimile or the like), in addition to the personal computer.

Furthermore, the technique described in the background section (for example, a transmission condition) may be adopted as processing contents of each module.

The program described above may be provided in a state of being stored in a recording medium or be provided by a communication unit. In this case, for example, the program described above may be considered as an invention of a “computer readable recording medium having a program recorded therein”.

The “computer readable recording medium having a program recorded therein” refers to a recording medium used for installation, execution, distribution or the like of the program in which the program is recorded and readable by a computer.

The recording medium may include, for example, a digital versatile disk (DVD) such as “DVD-R, DVD-RW, DVD-RAM, or the like” that are standards formulated by the DVD forum, “DVD+R, DVD+RW or the like” that are standards formulated by the DVD+RW, a compact disk (CD) such as a CD-read only memory (CD-ROM), a CD-recordable (CD-R), a CD-rewritable (CD-RW) or the like, a Blu-ray Disc, a magnetooptical disk (MO), a flexible disk (FD), a magnetic tape, a hard disk, a read-only memory (ROM), an electrically erasable programmable read-only memory (EEPROM (registered trademark)), a flash memory, a random access memory (RAM), a secure digital (SD) memory card, or the like.

A portion or the entirety of the program may be recorded in the recording medium to be saved or distributed. The portion or the entirety of the program may be transmitted, by communication, using a transmission medium such as a wired communication network, a wireless communication network, and a combination of the wired communication network and the wireless communication network, that are used, for example, in a local area network (LAN), a metropolitan area network (MAN), a wide area network (WAN), the Internet, the Ethernet, and an extra network, or may be carried by being superposed on a carrier wave.

Furthermore, the program may be a portion or the entirety of another program or may be recorded in the recording medium together with a separate program. The program may be divided to be recorded in plural recording media. The program may be recorded in any format such as a compressed format, an encrypted format, or the like as long as the program is able to be restored

What is claimed is:

1. An information processing apparatus comprising:
a first communication unit that communicates with a first device connected to a first communication line;
a second communication unit that communicates with a second device connected to a second communication line different from the first communication line;
a first transmission unit that adds identification information identifying the processing to the request for processing and transmits a request for processing to the second device using the second communication unit in a case where the first communication unit receives the request for processing and the request for processing is suitable for a condition in which transmission is performed using the second communication unit;
a control unit that performs control such that the identification information and the first communication unit are correlated with each other and are stored in a storage unit; and
a second transmission unit that extracts a communication unit correlated with the identification information using the storage unit and transmits a result of the processing to the first device using the extracted communication unit in a case where the result of the processing added with the identification information is received from the second device.

2. The information processing apparatus according to claim 1, further comprising:
a changing unit that changes such that the request for processing so as to be capable of being received by the second device.

3. The information processing apparatus according to claim 1,
wherein the control unit performs control such that the identification information, the first communication unit of a transmission source and the second communication unit of a transmission destination are correlated with each other and are stored in the storage unit,
wherein the second transmission unit extracts the communication unit of the transmission source correlated with the identification information using the storage unit and transmits the request to the first device using the communication unit in a case where a request regarding the processing and added with the identification information is received from the second device, and
wherein the control unit performs control such that the second communication unit is stored as the transmission source correlated with the identification information within the storage unit and the first communication unit is stored as the transmission destination correlated with the identification information within the storage unit,
the information processing apparatus further comprising:
a third transmission unit that extracts a communication unit of the transmission source correlated with the identification information using the storage unit and transmits the information regarding the processing to the second device using the communication unit in a case where information regarding the processing added with the identification information is received from the first device.

4. The information processing apparatus according to claim 1, further comprising:
a third transmission unit that transmits a name of processing provided by the second device to the first device in a case where the request for processing is suitable for a condition in which a request for processing is able to be transmitted from the first communication line to the second communication line.

5. The information processing apparatus according to claim 1,
wherein the second transmission unit notifies a result of the processing to a notification destination of a requestor in a case where the first communication unit receives a request for processing and a notification destination of a requestor.

6. The information processing apparatus according to claim 1, further comprising:
a processing unit that performs the processing or the predetermined processing in a case where a result of the processing and added with the identification information and processing to be performed by the information processing apparatus are received from the second device or in a case where predetermined processing exists,
wherein the second transmission unit transmits a processing result by the processing unit to the first device.

7. A non-transitory computer readable medium storing a program causing a computer to execute a process for:
communicating with a first device connected to a first communication line;
communicating with a second device connected to a second communication line different from the first communication line;
adding identification information identifying the processing to a request for processing, and transmitting the request for processing to the second device using the second communication line, in a case where the request for processing is received from the first device and the request for processing is suitable for a condition in which transmission is performed using the second communication line;
performing control such that the identification information and the communication in the first communication line are correlated with each other and are stored in a storage unit; and
extracting a communication line correlated with the identification information using the storage unit, and transmitting a result of the processing to the first device using the extracted communication line in a case where the result of the processing added with the identification information is received from the second device.

8. The non-transitory computer readable medium according to claim 7, further comprising:
a changing unit that changes such that the request for processing so as to be capable of being received by the second device.

9. The non-transitory computer readable medium according to claim 7,
wherein the control unit performs control such that the identification information, the first communication unit of a transmission source and the second communication unit of a transmission destination are correlated with each other and are stored in the storage unit,
wherein the second transmission unit extracts the communication unit of the transmission source correlated with the identification information using the storage unit and transmits the request to the first device using the communication unit in a case where a request regarding the processing and added with the identification information is received from the second device, and
wherein the control unit performs control such that the second communication unit is stored as the transmission source correlated with the identification information within the storage unit and the first communication unit is stored as the transmission destination correlated with the identification information within the storage unit,
the information processing apparatus further comprising:
a third transmission unit that extracts a communication unit of the transmission source correlated with the identification information using the storage unit and transmits the information regarding the processing to the second device using the communication unit in a case where information regarding the processing added with the identification information is received from the first device.

10. The non-transitory computer readable medium according to claim 7, further comprising:
a third transmission unit that transmits a name of processing provided by the second device to the first device in a case where the request for processing is suitable for a condition in which a request for processing is able to be transmitted from the first communication line to the second communication line.

11. The non-transitory computer readable medium according to claim 7,
wherein the second transmission unit notifies a result of the processing to a notification destination of a requestor in a case where the first communication unit receives a request for processing and a notification destination of a requestor.

12. The non-transitory computer readable medium according to claim 7, further comprising:
a processing unit that performs the processing or the predetermined processing in a case where a result of the processing and added with the identification information and processing to be performed by the information processing apparatus are received from the second device or in a case where predetermined processing exists,
wherein the second transmission unit transmits a processing result by the processing unit to the first device.

13. An information processing method, comprising:
communicating with a first device connected to a first communication line;
communicating with a second device connected to a second communication line different from the first communication line;
adding identification information identifying a processing to the request for processing, and transmitting the request for processing to the second device using the second communication line, in a case where the request for processing is received from the first device and the request for processing is suitable for a condition in which transmission is performed using the second communication line;
performing control such that the identification information and the communication in the first communication line are correlated with each other and are stored in a storage unit; and
extracting a communication line correlated with the identification information using the storage unit, and transmitting a result of the processing to the first device using the extracted communication line, in a case where the result of the processing added with the identification information is received from the second device.

14. The information processing method according to claim 13, further comprising:
a changing unit that changes such that the request for processing so as to be capable of being received by the second device.

15. The information processing method according to claim 13,
wherein the control unit performs control such that the identification information, the first communication unit of a transmission source and the second communication unit of a transmission destination are correlated with each other and are stored in the storage unit,
wherein the second transmission unit extracts the communication unit of the transmission source correlated with the identification information using the storage unit and transmits the request to the first device using the communication unit in a case where a request regarding the processing and added with the identification information is received from the second device, and
wherein the control unit performs control such that the second communication unit is stored as the transmission source correlated with the identification information within the storage unit and the first communication unit is stored as the transmission destination correlated with the identification information within the storage unit,
the information processing apparatus further comprising:
a third transmission unit that extracts a communication unit of the transmission source correlated with the identification information using the storage unit and transmits the information regarding the processing to the second device using the communication unit in a case where information regarding the processing added with the identification information is received from the first device.

16. The information processing method according to claim 13, further comprising:
a third transmission unit that transmits a name of processing provided by the second device to the first device in a case where the request for processing is suitable for a condition in which a request for processing is able to be transmitted from the first communication line to the second communication line.

17. The information processing method according to claim 13,
wherein the second transmission unit notifies a result of the processing to a notification destination of a requestor in a case where the first communication unit receives a request for processing and a notification destination of a requestor.

18. The information processing method according to claim 13, further comprising:
a processing unit that performs the processing or the predetermined processing in a case where a result of the processing and added with the identification information and processing to be performed by the information processing apparatus are received from the second device or in a case where predetermined processing exists,
wherein the second transmission unit transmits a processing result by the processing unit to the first device.
